(19) United States
(12) Patent Application Publication
(10) Pub. No.: US 2006/0049534 A1
(43) Pub. Date: Mar. 9, 2006

(54) Method of manufacturing half-finished lenses

(76) Inventor: Ching-Ho Lai, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/935,678

(22) Filed: Sep. 7, 2004

(51) Int. Cl. B29D 11/00

(52) U.S. Cl. 264/1.7; 264/2.7

(57) ABSTRACT

Provided is a process of manufacturing lenses from a half-finished product. The process comprises forming a nosepad on a center of an outer surface of the half-finished product for sufficiently separating one half-finished product from an adjacent half-finished product; forming two upwardly bent hanging members at both top ends of the half-finished product; and cutting the half-finished product into a pair of lenses. By utilizing the invention, adjacent half-finished products are not subject to collision each other. Moreover, potential error is eliminated in a subsequent cutting process of the half-finished product for forming lenses of a pair of eyeglasses since the nosepad is served as a reference point.

### FIELD OF THE INVENTION

The present invention relates to lens manufacturing processes and more particularly to a method of manufacturing lenses from a half-finished product with improved characteristics.

### BACKGROUND OF THE INVENTION

A conventional half-finished product to be formed as lenses of a pair of safety glasses, sunglasses, etc. is shown in FIG. 1. Two upwardly bent hanging members 101 are formed at both top ends of the integral half-finished product (i.e., the lens member) 10. The provision of the hanging members 101 is to facilitate conveying the lens members 10 in the manufacturing process. However, adjacent lens members 10 tend to collide each other since there is no projected member formed thereon for sufficiently separating them. As a result, the lens member 10 may be damaged by scratch. Moreover, error may occur in a subsequent cutting process since no reference point is formed on the lens member 10. Hence, a need for improvement exists.

### SUMMARY OF THE INVENTION

It is an object of the present invention to provide a process of manufacturing lenses from a half-finished product, comprising forming a nosepad on a center of an outer surface of the half-finished product for sufficiently separating one half-finished product from an adjacent half-finished product; forming two upwardly bent hanging members at both top ends of the half-finished product; and cutting the half-finished product into a pair of lenses. By utilizing the present invention, adjacent half-finished products are not subject to collision each other. Moreover, potential error is eliminated in a subsequent cutting process of the half-finished product for forming lenses of a pair of eyeglasses since the nosepad is served as a reference point.

The above and other objects, features and advantages of the present invention will become apparent from the following detailed description taken with the accompanying drawings.

### BRIEF DESCRIPTION OF THE DRAWINGS

FIG. 1 is a perspective view of a conventional half-finished product to be formed as lenses;

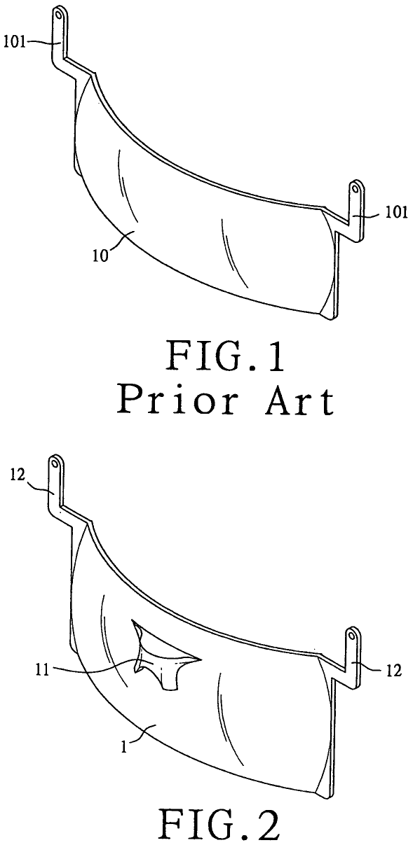

FIG. 2 is a perspective view of a half-finished product to be formed as lenses according to the invention; and

FIGS. 3 and 4 are perspective views for schematically illustrating a process of forming two types of lenses from the half-finished product according to the invention respectively.

### DETAILED DESCRIPTION OF THE PREFERRED EMBODIMENTS

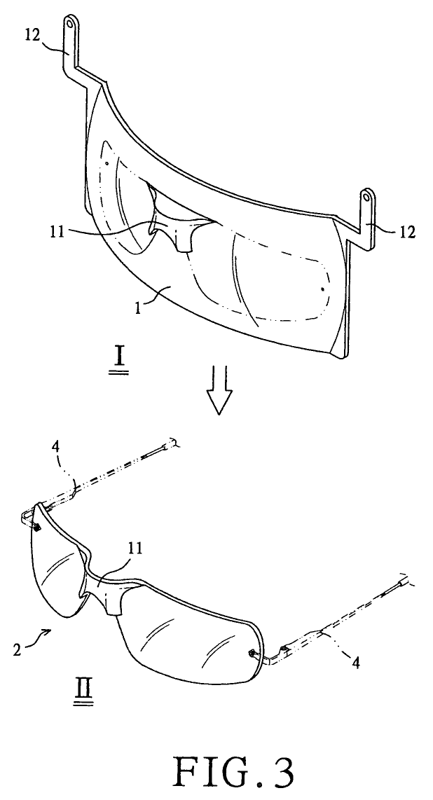

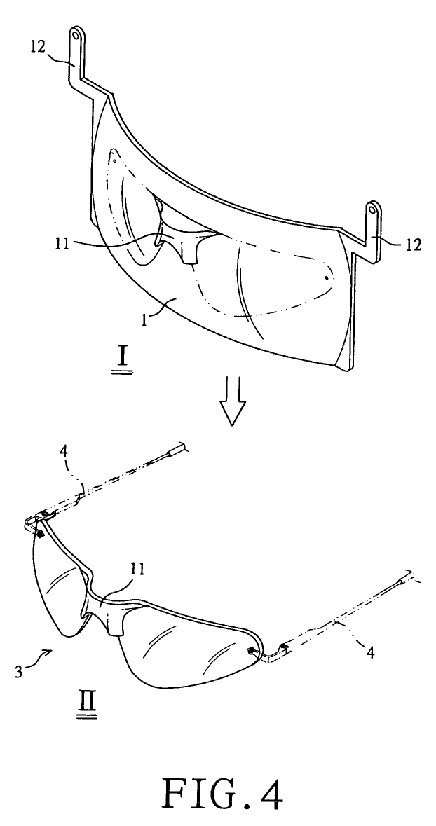

Referring to FIGS. 2, 3, and 4, there is shown a process of manufacturing lenses from a half-finished product in accordance with the invention. As shown in part A of FIG. 3 or FIG. 4, a nosepad 11 is formed on a center of an outer surface of a half-finished product (i.e., lens member) 1. Also, two upwardly bent hanging members 12 are formed at both top ends of the lens member 1. By configuring as above, adjacent lens member 1 are not subject to collision each other since there is a sufficient separation therebetween. As a result, no damage may be done to the lens members 1 in the manufacturing process. Moreover, potential error is eliminated in a subsequent cutting process of the lens member 1 for either forming lenses of one type of eyeglasses 2 (see part B of FIG. 3) or forming lenses of another type of eyeglasses 3 (see part B of FIG. 4) since the nosepad 11 is served as a reference point. Finally, a pair of temples 4 are mounted in endpieces of a frame of the eyeglasses 2 or 3 after fitting the lenses in the frame. Either type of the eyeglasses can be implemented as a pair of safety glasses, sunglasses, or the like.

While the invention herein disclosed has been described by means of specific embodiments, numerous modifications and variations could be made thereto by those skilled in the art without departing from the scope and spirit of the invention set forth in the claims.

What is claimed is:

1. A process of manufacturing lenses from a half-finished product, comprising:
forming a nosepad on a center of an outer surface of the half-finished product for sufficiently separating one half-finished product from an adjacent half-finished product;
forming two upwardly bent hanging members at both top ends of the half-finished product; and
cutting the half-finished product into a pair of lenses.
